(19) United States
(12) Patent Application Publication
(10) Pub. No.: US 2008/0002154 A1
(43) Pub. Date: Jan. 3, 2008

(54) Projection display device and control method thereof

(75) Inventor: Kazuyuki Ooishi, Yokohama-shi (JP)

Correspondence Address: BLAKELY SOKOLOFF TAYLOR & ZAFMAN, 1279 OAKMEAD PARKWAY, SUNNYVALE, CA, 94085-4040, US

(73) Assignee: Kabushiki Kaisha Toshiba

(21) Appl. No.: 11/820,622

(22) Filed: Jun. 19, 2007

(30) Foreign Application Priority Data
Jun. 30, 2006 (JP) 2006-182656

(51) Int. Cl. G03B 21/14; G03B 21/00

(52) U.S. Cl. 353/21; 353/122

(57) ABSTRACT

According to one embodiment, a projection display device includes a panel which modulates outgoing light from a light source by an image signal, a projection lens which projects image light outgoing from the panel, an imaging unit which converts an optical image entered via the projection lens to the image signal, and a control unit which selectively forms a first light path in which the image light outgoing from the panel is guided to the projection lens, and a second light path in which the optical image entered via the projection lens is guided to the imaging unit.

### CROSS-REFERENCE TO RELATED APPLICATIONS

This application is based upon and claims the benefit of priority from Japanese Patent Application No. 2006-182656, filed Jun. 30, 2006, the entire contents of which are incorporated herein by reference.

### BACKGROUND

1. Field

One embodiment of the invention relates to improvement of a projection display device represented by, for example, a liquid crystal color projector and the like, and a control method thereof.

2. Description of the Related Art

A projection display device as mentioned above is widely known to be capable of displaying information enlarged in size in high image quality on a big screen, and is useful when explanation and the like are made by letting many people visually recognize information at once. For this reason, the projection display device is widely used in a situation such as a presentation and a meeting, for example.

When information is displayed by using the projection display device, a usage type adopted in many cases is such that the information is projected onto a whiteboard by the projection display device, and handwriting of letters, figures, and the like is written on the whiteboard while such handwriting overlaps with the projected information being displayed.

In this case, in addition to the projected information being displayed on the whiteboard by the projection display device, information of the handwriting of letters, figures, and the like written on the whiteboard needs to be recorded together with the projected information. For this reason, a variety of methods have been developed so far in order to record the handwritten information together with the information being projected and displayed.

Jpn. Pat. Appln. Publication No. 2006-053313 discloses an image projection apparatus with photographing function and data management system using the apparatus capable of photographing data added in presentation and original data together to easily reflect the added data onto the original data, and deleting the original data from the photographed data so that only the added data can be checked.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view showing an embodiment of the present invention to explain an outline of a color projector;

FIG. 2 is a view shown to explain an overview of a projection display system using the color projector in the embodiment;

FIG. 3 is a view shown to schematically explain an optical system of the color projector in the embodiment;

FIGS. 4A to 4C are views each of which is shown to explain projected information of the color projector and added information in the embodiment;

FIG. 5 is a view shown to explain pasting of the added information on the projected information of the color projector in the embodiment;

FIG. 6 is a block configuration diagram shown to explain a signal processing system of the color projector in the embodiment;

FIG. 7 is a flowchart shown to explain processing operation at the time of projecting and photographing of the color projector in the embodiment;

FIG. 8 is a view showing a modification of the embodiment and shown to explain the optical system at the time of projection of the color projector;

FIG. 9 is a view shown to explain the optical system at the time of photographing of the color projector in the modification of the embodiment;

FIG. 10 is a block configuration diagram shown to explain the signal processing system of the color projector in the modification of the embodiment; and

FIG. 11 is a flowchart shown to explain processing operation at the time of projecting and photographing of the color projector in the modification of the embodiment.

### DETAILED DESCRIPTION

Various embodiments according to the invention will be described hereinafter with reference to the accompanying drawings. In general, according to one embodiment of the invention, a projection display device includes a panel which modulates outgoing light from a light source by an image signal, a projection lens which projects image light outgoing from the panel, an imaging unit which converts an optical image entered via the projection lens to the image signal, and a control unit which selectively forms a first light path in which the image light outgoing from the panel is guided to the projection lens, and a second light path in which the optical image entered via the projection lens is guided to the imaging unit.

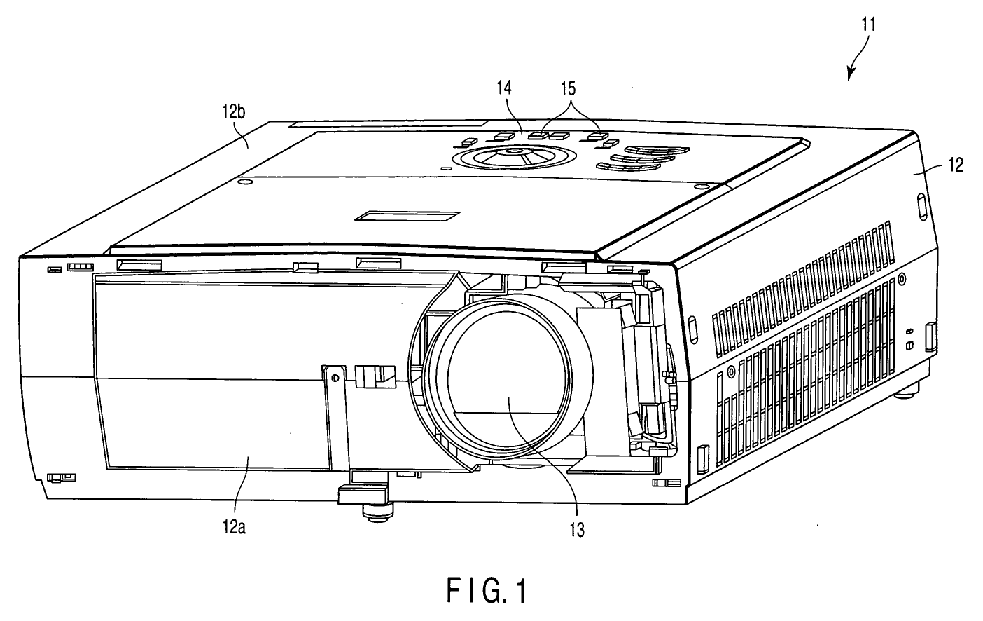

FIG. 1 shows an outline of a color projector 11 explained in the embodiment. That is, the color projector 11 has a cabinet 12 of a stationary type substantially formed in a thin box shape as a projector main body.

The cabinet 12 has a projection lens 13 arranged at one end of a front panel 12a of the cabinet 12. The projection lens 13 is used for displaying visualized information by enlarging and projecting such visualized information on a whiteboard to be described later which works as an image projected surface provided in front of the cabinet 12.

In addition, the cabinet 12 has an operation unit 14 arranged on a central part on a rear edge side of a top panel 12b of the cabinet 12. The operation unit 14 includes a variety of keys 15 used for controlling the color projector 11 to be in a variety of operation states or a stoppage state. The keys 15 are mounted to be exposed on the top panel 12b so that the user can operate the keys 15.

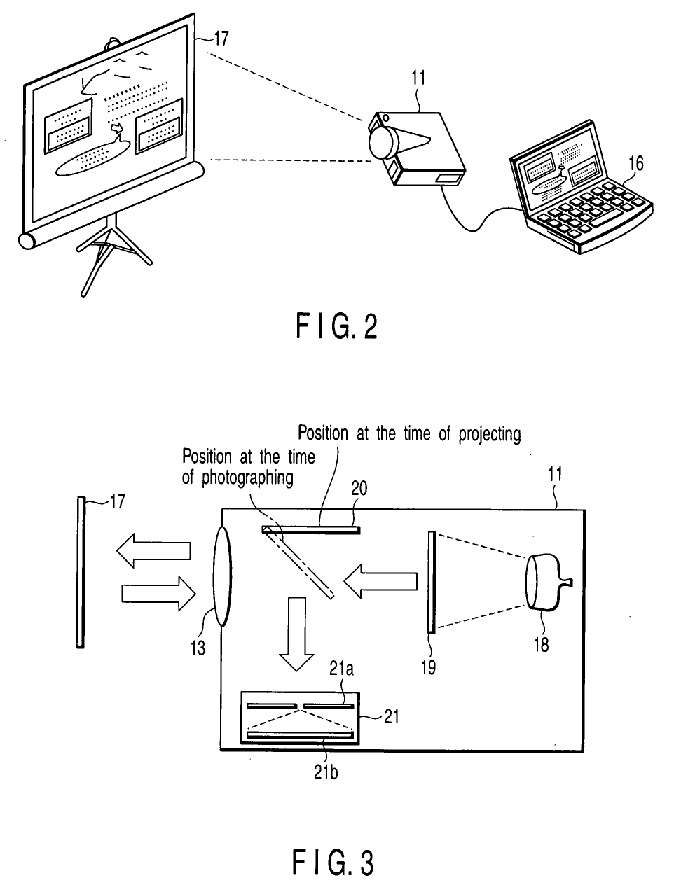

FIG. 2 shows an overview of a projection display system using the color projector 11. That is, the color projector 11 is connected to a PC (personal computer) 16 working as an information supplying source, and visualizes information supplied from the PC 16 and projects and displays the visualized information on a whiteboard 17. In addition, on the whiteboard 17, information such as letters and figures can be additionally written by handwriting so as to overlap the information being projected and displayed.

FIG. 3 schematically shows an optical system of the color projector 11. That is, outgoing light from a light source 18 incorporated in the color projector 11 is radiated on a liquid crystal panel 19. The liquid crystal panel 19 includes a display surface which is driven by the information supplied from the PC 16. In this manner, the liquid crystal panel 19 outputs image light which is obtained by modulating the outgoing light from the light source 18 by an image signal for projection display supplied from the PC 16.

Then, the image light outgoing from the liquid crystal panel 19 is projected and displayed on the whiteboard 17 via the projection lens 13, in a manner that a mirror 20 interposed between the liquid crystal panel 19 and the projection lens 13 is controlled to be located at an illustrated position to form a first light path in which the image light outgoing from the liquid crystal panel 19 is guided to the projection lens 13 at the time of projection.

In addition, the color projector 11 includes an imaging unit 21. The imaging unit 21 has a mechanical diaphragm mechanism 21a, and a solid-state imaging device 21b including a CCD (charge coupled device) which is used for converting an incoming optical image through the diaphragm mechanism 21a to an electric image signal.

Then, the color projector 11 includes a photographing mechanism that enters the optical image of an object to be imaged via the projection lens 13 from outside the color projector 11 and converts the optical image to an image signal in the imaging unit 21. At the time of such photographing, the mirror 20 is controlled to be located at an illustrated position to form a second light path in which the optical image of the object to be imaged entering via the projection lens 13 is reflected on the mirror 20 to be guided to the imaging unit 21.

In this manner, the color projector 11 can photograph the information added by handwriting on the whiteboard 17 and obtain the information as the image signal. In this case, if a length of the light path from the projection lens 13 to a light receiving surface of the solid-state imaging device 21b is set to be equal to a length of the light path from the liquid crystal panel 19 to the projection lens 13, photographing can be carried out with a focus of the projection lens 13 adjusted at the time of projection as it is. At the time of photographing, a measure needs to be taken, such as shielding the outgoing light from the light source 18, so that the outgoing light from the light source 18 does not enter into the imaging unit 21.

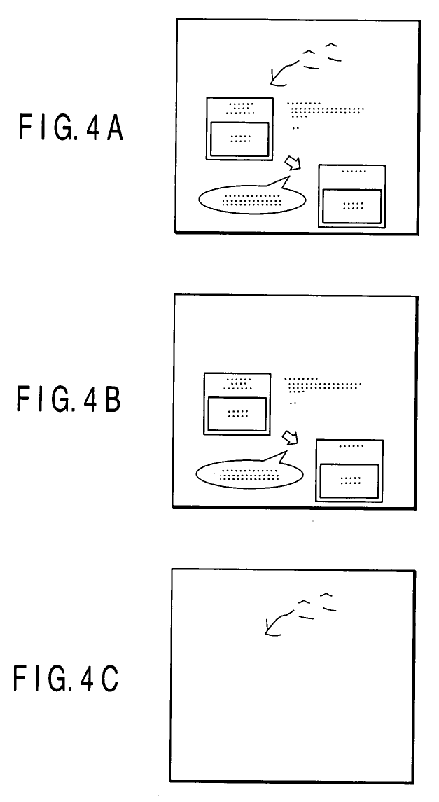

FIG. 4A shows information visually recognized on the whiteboard 17. The information visually recognized on the whiteboard 17 is formed by overlapping the information output by the PC 16 and projected on the whiteboard 17 by the color projector 11 as shown in FIG. 4B with the information added by handwriting and so on to the whiteboard 17 as shown in FIG. 4C.

Here, the information projected on the whiteboard 17 by the color projector 11 is already retained in the PC 16. Therefore, only the information added by handwriting and so on to the whiteboard 17 is photographed by the color projector 11. The image signal obtained by the photographing is taken into the PC 16, and is retained as a file, for example, in a JPEG format, TIF format, and so on.

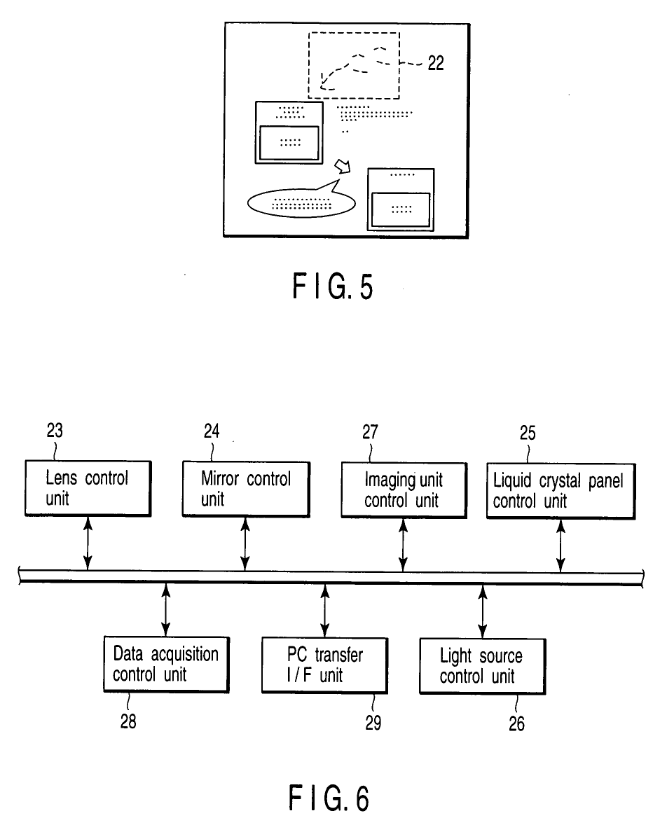

Then, in the PC 16, as shown in FIG. 5, the added information (file) photographed by the color projector 11 is pasted on (combined with) the projected information (file) by the color projector 11, and the obtained information is recorded. In this case, the added information can be enlarged and reduced in size, and pasting position thereof can be moved, therefore the user can record the added information after editing the information as appropriate.

Basically, when the projected information with the added information pasted thereon is recorded, the projected information and the added information desirably have a positional relationship which is actually visually recognized on the whiteboard 17. However, in practice, there is a case where the information is hard to be recognized when letters and figures in the added information are written by overlapping with letters and figures of the projected information. In such a case, the information can be recorded after the information is edited to be easily recognized by enlarging or reducing the added information in size or moving the position of the added information. In FIG. 5, a broken line 22 surrounding the added information is displayed on the PC 16 at the time of editing the added information by enlarging and reducing in size and moving the position, and is not recorded in the PC 16.

FIG. 6 shows a signal processing system of the color projector 11. That is, when the information supplied from the PC 16 is projected, the lens control unit 23 carries out focus adjustment (focusing) with respect to the projection lens 13. In addition, the mirror control unit 24 moves the mirror 20 to the position at the time of projecting. The projected information is supplied to the liquid crystal panel 19 by the liquid crystal panel control unit 25 and displayed. Further, a light source control unit 26 starts output of light from the light source 18. The focus adjustment of the projection lens 13 may be carried out by hand.

On the other hand, when the added information on the whiteboard 17 is photographed, the mirror control unit 24 moves the mirror 20 to the position at the time of photographing. Then, an imaging unit control unit 27 controls the imaging unit 21 to photograph the added information. At the time of photographing, the light source control unit 26 turns off light of the light source 18, or a mechanism for shielding outgoing light from the light source 18 from entering into the imaging unit 21 is controlled. In addition, as described above, at the time of photographing, the photographing can be carried out with the focus of the projection lens 13 which is adjusted at the time of projecting as it is. Therefore, the lens control unit 23 does not need to carry out the focus adjustment. Then, the image signal of the added information obtained by the imaging unit 21 is transferred to the PC 16 via a PC transfer I/F (interface) unit 29 after a luminance adjustment processing and so on are applied by a data acquisition control unit 28.

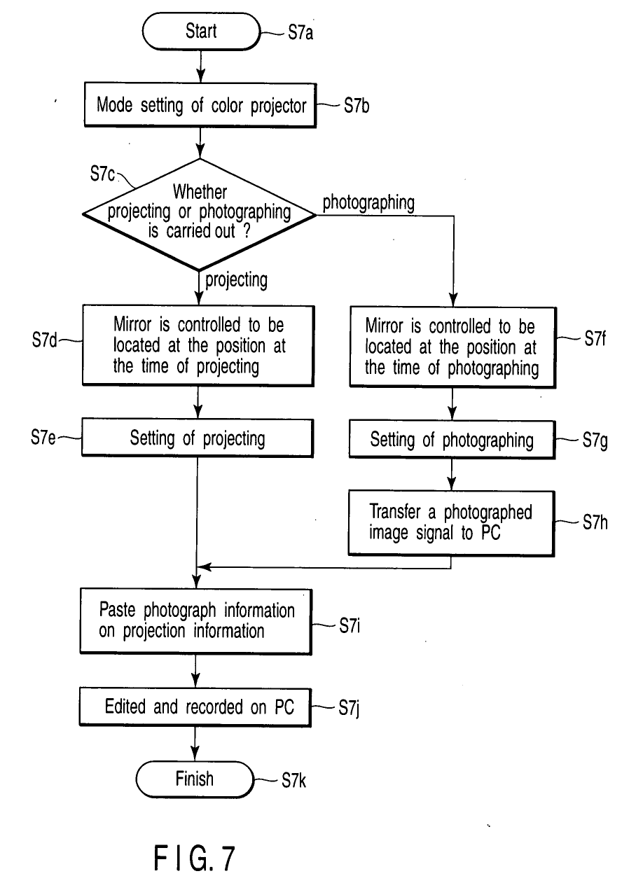

FIG. 7 shows a flowchart summarizing processing operation at the times of projecting and photographing of the color projector 11. That is, when the processing is started (block S7a), a mode setting of the color projector 11 is carried out in block S7b. In the mode setting, connection between the color projector 11 and the PC 16, power supplying of the color projector 11, and so on are carried out.

Thereafter, whether projecting or photographing is carried out is set in block S7c. In a case the projecting is set, the mirror 20 is controlled to be located at the position at the time of projecting where the mirror 20 is moved away from between the liquid crystal panel 19 and the projection lens 13 in block S7d, and then setting of projecting is carried out in block S7e. The setting of projecting includes adjusting of size of a projection screen with respect to the whiteboard 17 and focusing with respect to the projection lens 13.

In addition, in a case the photographing is set in block S7c, the mirror 20 is controlled to be located at the position at the time of photographing where the mirror 20 guides the optical image entering into the projection lens 13 from outside to the imaging unit 21 in block S7f, and then setting of photographing is carried out in block S7g. In the setting of photographing, although the focus adjustment with respect to the projection lens 13 is basically not necessary, adjustment of a mechanical error and brightness is necessary. Thereafter, the image signal obtained by photographing the added information is transferred to the PC 16 in block S7h.

Then, pasting of the added information which has been photographed on the projected information of the PC 16 is carried out in block S7i after block S7e or block S7h described above. In block S7j, the edit processing in which a color, size, position, and so on of the added information are changed as needed is carried out and the edited information is recorded in the PC 16. Then, the processing is finished (block S7k).

According to the embodiment described above, a function of photographing the information added by handwriting to the whiteboard 17 is provided in the color projector 11, and the added information which has been photographed is edited, and then recorded in the PC 16 after being pasted on the projected information projected and displayed. Therefore, the information added by handwriting and so on can be recorded after the added information is effectively overlapped with the information projected and displayed.

In particular, only the added information is photographed, and the projected information and the added information are not recorded as integrated data, therefore the edit processing in which a color, size, position, and so on of the added information are changed can be carried out. In this manner, a degree of freedom at the time of pasting the added information on the projected information can be increased. In addition, special equipment is not necessary for the whiteboard 17, a screen, and so on, on which information is projected. Therefore, there is an advantageous effect that a location on which information is projected is not limited.

Further, the projection lens 13 is commonly used at the times of projecting and photographing, and the length of the light path from the projection lens 13 to the light receiving surface of the solid-state imaging device 21b is set to be equal to the length of the light path from the liquid crystal panel 19 to the projection lens 13. In this manner, at the time of photographing, the photographing can be carried out with the focus of the projection lens 13 adjusted at the time of projecting. Therefore, the present embodiment includes a simple configuration that facilitates handling by the user, and is suitable for practical use.

In the embodiment described above, the letters and figures written by handwriting on the whiteboard 17 is exemplified as the added information. However, the added information is not limited thereto, and may include, for example, a photograph, a document, and so on attached on the whiteboard 17.

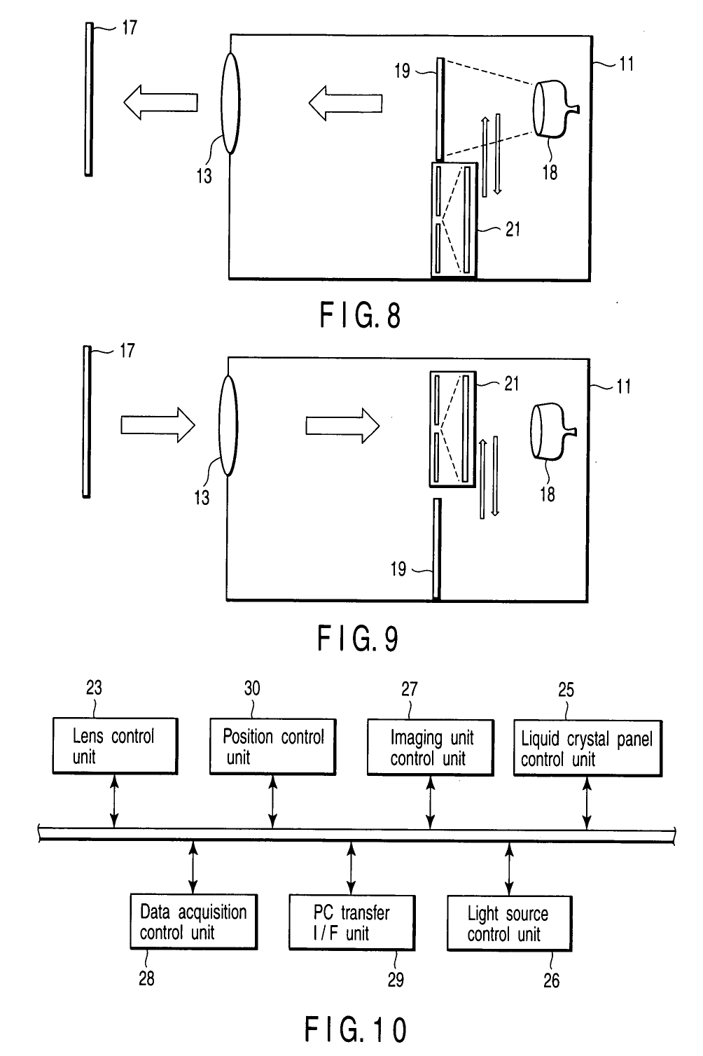

FIGS. 8 and 9 show a modification of the embodiment described above. That is, when such a modification is described by attaching an identical numerical number to a part identical to a part in FIG. 3, the mirror 20 is not used, and the liquid crystal panel 19 and the imaging unit 21 are made mechanically move such that, as shown in FIG. 8, at the time of projecting, positioning at the time of projecting is carried out to form the first light path in which the liquid crystal panel 19 is interposed between the light source 18 and the projection lens 13, and the image light obtained by modulating the outgoing light from the light source 18 by the projected information from the PC 16 is supplied to the projection lens 13. Also, at the time of photographing, as shown in FIG. 9, positioning at the time of photographing is carried out to form the second light path in which the imaging unit 21 is interposed between the light source 18 and the projection lens 13, and the imaging unit 21 receives light of the optical image entering into the imaging unit 21 through the projection lens 13.

In this case as well, the length of the light path from the projection lens 13 to the light receiving surface of the solid-state imaging device 21b is set to be equal to the length of the light path from the liquid panel 19 to the projection lens 13, and photographing can be carried out with the focus of the projection lens 13 adjusted at the time of the projecting as it is.

FIG. 10 shows the signal processing system of the color projector 11 in the modification. In FIG. 10, when the modification is described by attaching an identical numerical number to a part identical to a part in FIG. 6, at the time of projecting the information supplied by the PC 16, the lens control unit 23 carries out focus adjustment (focusing) of the projection lens 13. In addition, a position control unit 30 moves the liquid crystal panel 19 to a position at the time of projecting. Further, a liquid crystal panel control unit 25 supplies the projected information to the liquid crystal panel 19, and the projected information is displayed. In addition, the light source control unit 26 starts irradiation of light from the light source 18. The focus adjustment of the projection lens 13 may be carried out by hand.

On the other hand, at the time of photographing the added information on the whiteboard 17, the position control unit 30 moves the imaging unit 21 to a position at the time of photographing. Then, the imaging unit control unit 27 controls the imaging unit 21 to photograph the added information. At the time of photographing, the light source control unit 26 turns off light of the light source 18 or the mechanism for shielding outgoing light of the light source 18 from entering into the imaging unit 21 is controlled. In addition, as described above, at the time of photographing, the photographing can be carried out with the focus of the projection lens 13 adjusted at the time of projecting as it is. Therefore, the focus adjustment by the lens control unit 23 is not necessary. Then, the image signal of the added information obtained by the imaging unit 21 is transferred to the PC 16 via the PC transfer I/F unit 29 after the data acquisition control unit 28 applies the luminance adjustment processing and so on.

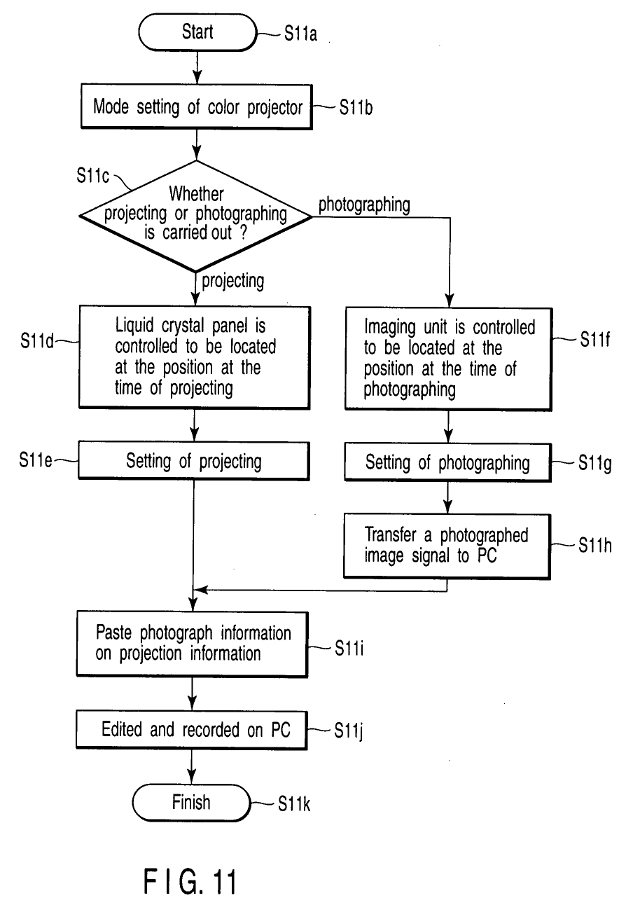

FIG. 11 shows a flowchart summarizing the processing operation at the time of the projecting and at the photographing of the color projector 11 in the modification described above. That is, when the processing is started (block S11a), the mode setting of the color projector 11 is carried out in block S11b. The mode setting includes connection between the color projector 11 and the PC 16, power supplying of the color projector 11, and so on.

Thereafter, whether projecting or photographing is carried out is set in block S11c. In a case the projecting is set, the liquid crystal panel 19 is controlled to be located at the position at the time of projecting in block S11d, and then setting of projecting is carried out in block S11e. The setting of projecting includes adjusting of size of a projection screen with respect to the whiteboard 17 and focusing with respect to the projection lens 13.

In addition, in a case the photographing is set in block S11c, the imaging unit 21 is controlled to be located at the position at the time of photographing in block S11f, and then setting of photographing is carried out in block S11g. In the setting of photographing, although the focus adjustment with respect to the projection lens 13 is basically not necessary, adjustment of a mechanical error and brightness is necessary. Thereafter, the image signal obtained by photographing the added information is transferred to the PC 16 in block S11h.

Then, pasting of the added information which has been photographed on the projected information of the PC 16 is carried out in block S11i after block S11e or block S11h described above. In block S11j, the edit processing in which a color, size, position, and so on of the added information are changed as needed is carried out and the edited information is recorded in the PC 16. Then, the processing is finished (block S11k).

As a matter of course, the modification can obtain an advantageous effect similar to that of the embodiment described above.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A projection display device comprising:
a light source;
a panel which modulates outgoing light from the light source by an image signal;
a projection lens which projects image light outgoing from the panel;
an imaging unit which converts an optical image entered via the projection lens to the image signal; and
a control unit which selectively forms a first light path in which the image light outgoing from the panel is guided to the projection lens, and a second light path in which the optical image entered via the projection lens is guided to the imaging unit.

2. A projection display device according to claim 1, further comprising:
a processing unit which combines the image signal obtained by the imaging unit with the image signal to be supplied to the panel.

3. A projection display device according to claim 2, wherein
the processing unit edits the image signal obtained from the imaging unit, and combines the image signal with the image signal to be supplied to the panel.

4. A projection display device according to claim 2, further comprising:
a recording unit which records the image signal combined in the processing unit.

5. A projection display device according to claim 1, wherein
a length of a light path from the panel to the projection lens is set to be equal to a length of a light path from the projection lens to the imaging unit.

6. A projection display device according to claim 1, wherein
the control unit selectively forms the first light path and the second light path by moving a mirror.

7. A projection display device according to claim 1, wherein
the control unit selectively forms the first light path and the second light path by moving the panel and the imaging unit.

8. A control method of a projection display device comprising a light source, a panel which modulates outgoing light from the light source by an image signal, a projection lens which projects image light outgoing from the panel, and an imaging unit which converts an optical image entered via the projection lens to the image signal, the method executing:
setting whether projecting or photographing is carried out;
forming a first light path in which the image light outgoing from the panel is guided to the projection lens when the projecting is set; and
forming a second light path in which the optical image entered via the projection lens is guided to the imaging unit when the photographing is set.

9. A control method of a projection display device according to claim 8, further comprising:
combining the image signal which the imaging unit obtains by forming the second path with the image signal supplied to the panel when the first light path is formed.

10. A control method of a projection display device according to claim 9, wherein
the combining the image signal includes editing the image signal which the imaging unit obtains when the second light path is formed and combining the edited image signal with the image signal supplied to the panel.

11. A control method of a projection display device according to claim 9, further comprising:
recording the image signal obtained by the combining the image signal.

12. A control method of a projection display device according to claim 8, wherein
the forming the first and second light paths includes selectively forming the first and second light paths by moving a mirror.

13. A control method of a projection display device according to claim 8, wherein
the forming the first and second light paths includes selectively forming the first and second light paths by moving the panel and the imaging unit.
